(19) United States
(12) Patent Application Publication
(10) Pub. No.: US 2025/0155053 A1
(43) Pub. Date: May 15, 2025

(54) Pipe Laying Machine and Pipe Laying Methods

(71) Applicant: Brent Nathaniel Bunting, Red Bluff, CA (US)

(72) Inventor: Brent Nathaniel Bunting, Red Bluff, CA (US)

(21) Appl. No.: 18/943,447

(22) Filed: Nov. 11, 2024

Related U.S. Application Data
(60) Provisional application No. 63/547,883, filed on Nov. 9, 2023.

(51) Int. Cl. F16L 1/028; F16L 1/06

(52) U.S. Cl. CPC F16L 1/028; F16L 1/065

(57) ABSTRACT

Pipe laying machines are provided. The machines can include: a platform configured to support a plurality of pipe; ambulatory assemblies supporting the platform and sufficiently spaced apart to straddle a trench; a pipe setting station located about a center portion of the platform; a pipe feeding assembly configured to provide pipe laterally to the pipe setting station; and a pipe ejection assembly configured to extend pipe lengthwise from the platform. Methods for laying pipe within a trench using a machine are provided. The methods can include: supporting a plurality of pipe above a trench with a machine; matriculating the trench with the supported pipe and the machine; laterally feeding the pipe to a pipe setting station using the machine; and extending the pipe lengthwise into the trench using the machine.

### CROSS REFERENCE TO RELATED APPLICATION

This application claims priority to and the benefit of U.S. Provisional Patent Application Ser. No. 63/547,883 filed Nov. 9, 2023, entitled “Pipe Laying Machine and Pipe Laying Methods”, the entirety of which is incorporated by reference herein.

### TECHNICAL FIELD

The field of the invention is construction equipment including pipe laying machines and pipe laying methods that can be used separately or in conjunction with trench preparation machines and trench preparation methods.

### BACKGROUND

Typically, when plastic pipes are being provided to within trenches it is a manually intensive job that requires multiple laborers and at least one or two construction machines and/or operators. This can be costly and expensive, and also increase the potential of danger to the laborers and the construction operators. For example, a trench is dug and then prepared, and a pipe is stretched along the exterior on the upper surface of the earth next to the trench for preparation and laying within the trench. Laborers are required to be inside and above the trench to put pipe in from the upper surface with the assistance of machines that ride along the upper surface. As is indicated, this can be very dangerous, as there could be trenching that collapses; pipes can be dropped; and the gluing can be troublesome as it occurs inside the trench rather than outside the trench.

These are just some of the numerous problems that are associated with the current methods. The present disclosure provides machines that can ride above the trench and systematically provide pipe to within the trench from a platform above the trench.

### SUMMARY

Pipe laying machines are provided. The machines can include: a platform configured to support a plurality of pipe; ambulatory assemblies supporting the platform and sufficiently spaced apart to straddle a trench; a pipe setting station located about a center portion of the platform; a pipe feeding assembly configured to provide pipe laterally to the pipe setting station; and a pipe ejection assembly configured to extend pipe lengthwise from the platform.

Methods for laying pipe within a trench using a machine are provided. The methods can include: supporting a plurality of pipe above a trench with a machine; matriculating the trench with the supported pipe and the machine; laterally feeding the pipe to a pipe setting station using the machine; and extending the pipe lengthwise into the trench using the machine.

### BRIEF DESCRIPTION OF DRAWINGS

Embodiments of the disclosure are described below with reference to the following accompanying drawings.

FIG. 1 is a depiction of a pipe laying machine according to an embodiment of the disclosure.

FIG. 2 is another view of the pipe laying machine of FIG. 1 according to an embodiment of the disclosure.

FIG. 3 is another view of the pipe laying machine of FIG. 1 according to an embodiment of the disclosure.

FIGS. 4A-4C are depictions of gluing configurations according to an embodiment of the disclosure.

FIG. 5A-5C are depictions of gluing configurations according to an embodiment of the disclosure.

FIG. 6 is a more detailed view of a gluing configuration as well as process circuitry associated with the positioning and gluing of the pipe in relation to the trench according to an embodiment of the disclosure.

FIG. 7 is another view of another embodiment of the pipe laying machine according to an embodiment of the disclosure.

### DESCRIPTION

This disclosure is submitted in furtherance of the constitutional purposes of the U.S. Patent Laws “to promote the progress of science and useful arts” (Article 1, Section 8).

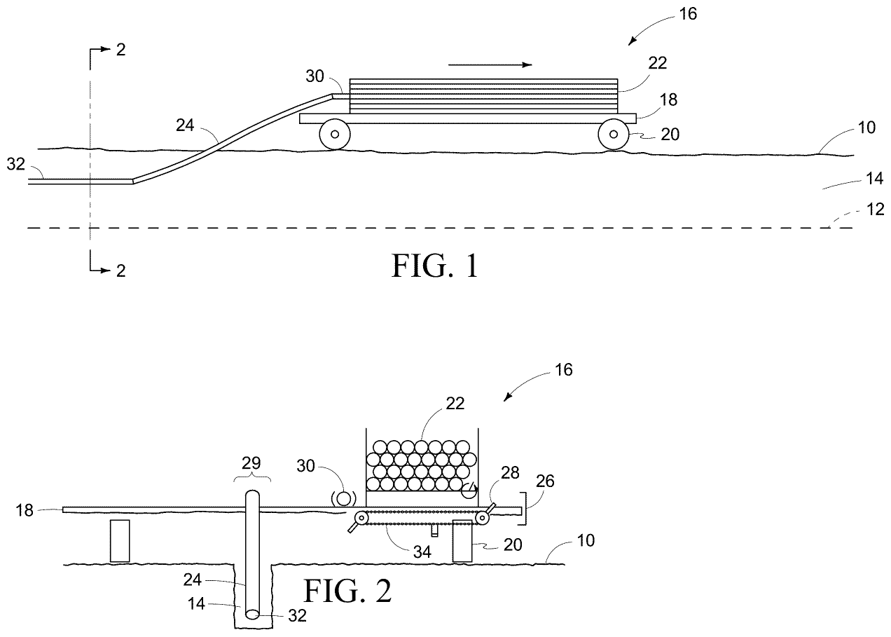

The pipe laying machines and methods will be described with reference to FIGS. 1-7. Referring first to FIG. 1, a pipe laying machine 16 is positioned above earth and surface 10 which includes a trench 14 having a bottom 12. Machine 16 can include a platform 18 that resides above ambulatory methods such as wheels 20, but can also include other methods that are contemplated, including but not limited to tracks. Machine 16 can be self-propelled, including a power source or motor, as well as being pulled by another machine such as a tractor, truck, or some other machine. Machine 16 can be configured to include a rack of pipe 22 and provide individual sections of pipe 32 and 24 and 30 from rack 22 as it resides in a direction along trench 14. In accordance with example implementations and with reference to FIG. 2, another view of machine 16 as it resides above trench 14 is shown from the rearward or posterior angle. In accordance with this angle, machine 16 can include racks of pipe 22 which also can be provided individually to the platform 18 at pipe setting station 29 for gluing and coupling to other pipes using pipe transport apparatus 26 which again includes a chain 34 and flippers 28, and can be controlled with computer processing circuitry and/or manually as desired. In accordance with example implementations, machine 16 can provide an individual pipe 30 for conjunction with a partially in ground pipe 24 that is already coupled to an existing pipe 32.

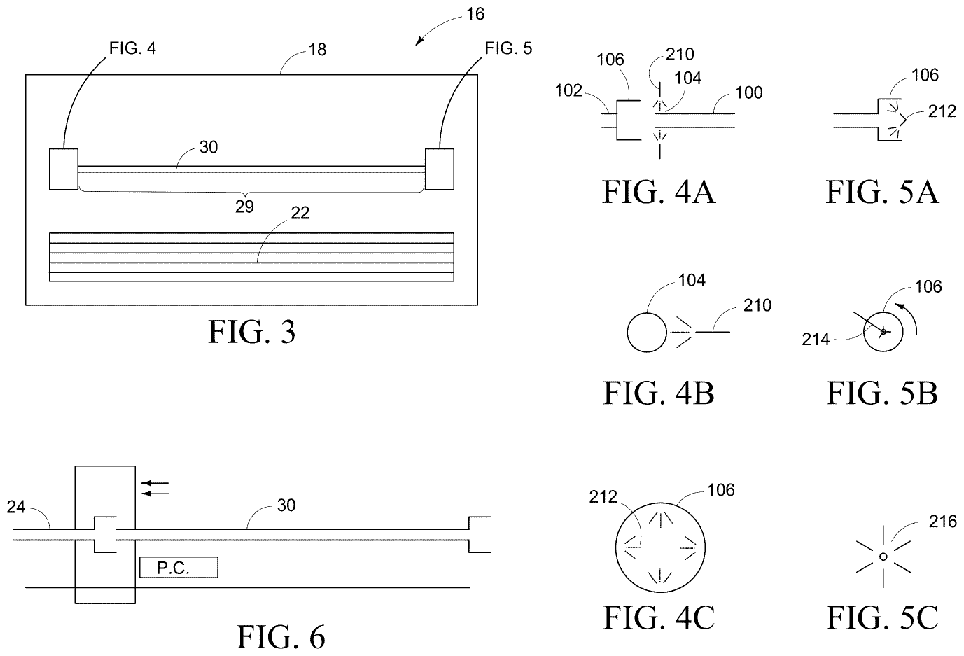

Referring next to FIG. 3, machine 16 can include platform 18 that resides above pipe 30 and multiple sections of pipe 22. In accordance with example implementations and with reference to FIGS. 4A-C and FIGS. 5A-C, portions of pipe 30 are shown in preparation for gluing. Referring first to FIG. 4A, a bell end 106 of pipe 102 can be aligned with another pipe 100. The gluing of terminus of pipe 100 can be configured as a halo of sprayers 210 about terminus 104. In accordance with example implementations with reference to FIG. 4B, another sprayer configuration 210 is shown as it sprays the exterior of terminus 104. In FIG. 4C, in accordance with another implementation, a series of sprayers can be aligned in a halo as shown in 106, and the terminus end can be inserted thereto. Referring next to FIG. 5A, a bell end 106 is shown with inserted sprayers 212 thereto, and in another configuration in FIG. 5B, a single wand flip-down sprayer 214 is shown. In FIG. 5C, a spray head 216 is shown to outwardly spray the inside of bell head 106. In accordance with example implementations, this glue can include PVC cement in sprayable form. Example glues can be electrical PVC gray cement, that is State of California compliant. The glue can include a combination of one or more of tetrahydrofuran, acetone, methyl ethyl ketone, polyvinyl chloride, cyclohexanone, and/or inorganics such as fumed silica. This glue can be flushed through the system using solvents on board the machine, if desired, as well as a series of clean up steps to ensure that the sprayers remain unclogged in between sprays.

Referring to FIG. 6, in accordance with example implementations, and either manually or utilizing computer processing circuitry, a pipe 30 can be configured to engage the bell end of already extended pipe 24 using processing circuitry. A push rod or pull rod or grips can be used to engage pipe 30 with pipe 24 after pipes 24 and 30 have been glued, for example, as shown with respect to the sprayers already described.

As indicated machine 16 can be configured with processing circuitry. In accordance with example implementations, these processes may be utilized in connection with the processing circuitry described. The processes may use software and/or hardware of the following combinations or types. For example, with respect to server-side languages, the circuitry may use Java, Python, PHP, .NET, Ruby, JavaScript, or Dart, for example. Some other types of servers that the systems may use include Apache/PHP, .NET, Ruby, NodeJS, Java, and/or Python. Databases that may be utilized are Oracle, MySQL, SQL, NoSQL, or SQLite (for Mobile). Client-side languages that may be used, this would be the user side languages, for example, are ASM, C, C++, C #, Java, Objective-C, Swift, ActionScript/Adobe AIR, or JavaScript/HTML5. Communications between the server and client may be utilized using TCP/UDP Socket based connections, for example, as Third-Party data network services that may be used include GSM, LTE, HSPA, UMTS, CDMA, WiMAX, WIFI, Cable, and DSL. The hardware platforms that may be utilized within processing circuitry include embedded systems such as (Raspberry PI/Arduino), (Android, IOS, Windows Mobile)—phones and/or tablets, or any embedded system using these operating systems, i.e., cars, watches, glasses, headphones, augmented reality wear etc., or desktops/laptops/hybrids (Mac, Windows, Linux). The architectures that may be utilized for software and hardware interfaces include x86 (including x86-64), or ARM.

The processing circuitry can be an assembly of components such as detectors, sensors, and/or computers. The detectors/sensors can be configured to gauge the motion of the machine along the trench, the depth of the trench, the length of pipe, the ends of the pipe (weather bell or non-bell), the alignment and/or relation of the pipe on the platform with the pipe extending in the trench, when the pipe is to be glued, etc. The processing circuitry can be configured to align a pipe for coupling, provide glue via sprayers to ends of pipe for coupling, couple glued pipes, then retain coupling of the pipes while the machine traverses the trench.

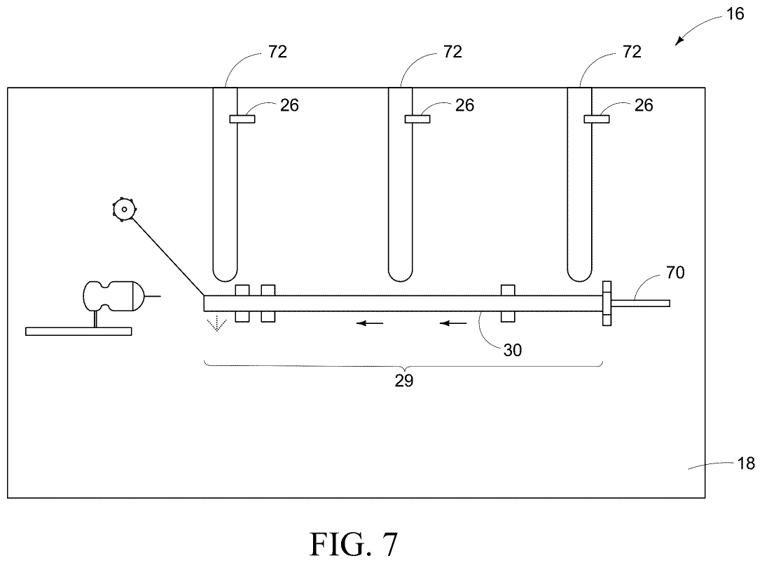

Referring next to FIG. 7, another example of machine 16 is shown that has individual pipe transfer assemblies 26 configured to operate within racks or rails 72 above platform 18. In accordance with example implementations, the machine can include push rod 70 which is configured to extend pipe 30 to within the next pipe 24 as described.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

The invention claimed is:

1. A pipe laying machine, the machine comprising:
a platform configured to support a plurality of pipe;
ambulatory assemblies supporting the platform and sufficiently spaced apart to straddle a trench;
a pipe setting station located about a center portion of the platform;
a pipe feeding assembly configured to provide pipe laterally to the pipe setting station; and
a pipe ejection assembly configured to extend pipe lengthwise from the platform.

2. The machine of claim 1 wherein the ambulatory assemblies include wheels or tracks.

3. The machine of claim 1 wherein the machine may be towed or self-propelled.

4. The machine of claim 1 wherein the pipe setting station is configured to receive and guide a section of pipe.

5. The machine of claim 1 wherein the pipe feeding assembly can be operably configured as an assembly of chains and flippers, wherein the chains are configured to control the rotation of the flippers, and the flippers are configured to laterally engage the pipe, the chains and flippers operably coupled to a motor.

6. The machine of claim 1 further comprising at least one gluing assembly arranged on the platform about at least one end of the pipe setting station.

7. The machine of claim 6 further comprising another gluing assembly, the one and other gluing assemblies arranged at opposing ends of the pipe setting station.

8. The machine of claim 6 wherein the gluing assembly is configured to provide glue to an exterior portion of one section of pipe for insertion into another section of pipe.

9. The machine of claim 6 wherein the gluing assembly is configured to provide glue to an interior portion of one section of pipe for receiving another section of pipe.

10. The machine of claim 1 further comprising processing circuitry operably coupled to one or more sensors and configured to control one or more motors operating the pipe setting station, the pipe feeding assembly, and/or the pipe ejection assembly.

11. The machine of claim 10 further comprising at least one gluing assembly, wherein the processing circuitry is configured to control pivotal extension/retraction of the gluing assembly as well as glue distribution.

12. A method for laying pipe within a trench using a machine, the method comprising:
supporting a plurality of pipe above a trench with a machine;
matriculating the trench with the supported pipe and the machine;
laterally feeding the pipe to a pipe setting station using the machine; and
extending the pipe lengthwise into the trench using the machine.

13. The method of claim 12 wherein the plurality of pipe is supported with a rack.

14. The method of claim 12 wherein the trench is matriculated linearly and ambulatory using ambulatory assemblies on opposing sides of the trench.

15. The method of claim 12 further comprising sensing when the pipe setting station is clear or occupied using processing circuitry.

16. The method of claim 15 further comprising laterally feeding the pipe when the pipe setting station is not occupied.

17. The method of claim 16 further comprising providing glue to one or both ends of the pipe while in the pipe setting station using the processing circuitry.

18. The method of claim 17 further comprising extending the pipe from the pipe setting station lengthwise to engage and couple with another section of pipe.

19. The method of claim 18 wherein the extending ejects a coupled section of pipe from the machine into the trench.

20. The method of claim 19 further comprising ejecting multiple sections of coupled pipe to lay a line of coupled sections at the base of the trench.
